(19) United States
(12) Patent Application Publication
(10) Pub. No.: US 2018/0165866 A1
(43) Pub. Date: Jun. 14, 2018

(54) SYSTEMS AND METHODS FOR ANIMATING MOVEMENT OF AGENTS

(71) Applicants: Peleg Kurland, Netanya (IL); Horse Place Ltd., Road Town (VG)

(72) Inventor: Zafrir FEIER, Tel-Aviv (IL)

(21) Appl. No.: 15/841,475

(22) Filed: Dec. 14, 2017

Related U.S. Application Data
(60) Provisional application No. 62/433,838, filed on Dec. 14, 2016.

(51) Int. Cl. G06T 13/80; G07F 17/32

(52) U.S. Cl. CPC G06T 13/80; G06Q 30/08; G07F 17/3288

(57) ABSTRACT

There is provided a method, comprising: receiving an agent dataset comprising a position and a velocity for each agent moving on a track presented on a display, identifying curve(s) of the track; performing, for each agent: identifying neighboring agents according to the respective position of each of the agents; computing a respective inter-agent distance to each of the neighboring agents; adjusting the position and/or the velocity according to the curve(s) and the distance to each of the neighboring agents; and updating instructions for rendering a presentation of an animation of a movement of the agents presented on the display according to the adjusted agent dataset that includes the adjusted position and/or velocity of each of the agents, wherein the performing and the updating are iterated dynamically to provide a realistic animation of the movement of the agents along the curve of the track.

### RELATED APPLICATIONS

This application claims the benefit of priority under 35 USC § 119(e) of U.S. Provisional Patent Application No. 62/433,838, filed on Dec. 14, 2016. The contents of the above application are all incorporated by reference as if fully set forth herein in their entirety.

### FIELD AND BACKGROUND OF THE INVENTION

The present invention, in some embodiments thereof, relates to movement of one or more agents along a curve of a track and, more specifically, but not exclusively, to systems and methods for computing instructions to render a presentation of an animation of the agent(s) moving along the track.

Software frameworks and/or engines provide programmers with a tool to simply and rapidly develop applications such as games. The frameworks typically provide generic components, such as graphics, sound, and animation. However, the generic components may not be suitable for all application, for example, failing to correctly resemble certain real-life scenarios.

### SUMMARY OF THE INVENTION

According to a first aspect, a computer implemented method for computing instructions that update a rendering of a presentation of an animation of a movement of agents, comprises: receiving an agent dataset comprising a position and a velocity for each of a plurality of agents moving on a track presented on a display, wherein the velocity is represented as a vector having a magnitude indicative of speed and a direction, wherein the vector is associated with the position defined using a set of coordinates based on a virtual environment representing the track; identifying at least one curve of the track; performing, for each agent of the plurality of agents: identifying neighboring agents of the plurality of agents according to the respective position of each of the plurality of agents; computing a respective inter-agent distance to each of the neighboring agents; adjusting at least one of the position and the velocity according to the at least one curve and the distance to each of the neighboring agents; and updating instructions for rendering a presentation of an animation of a movement of the agents presented on the display according to the adjusted agent dataset that includes the adjusted at least one of the position and velocity of each of the plurality of agents, wherein the performing and the updating are iterated dynamically to provide a realistic animation of the movement of the plurality of agents along the curve of the track.

According to a second aspect, a system for computing instructions that update a rendering of a presentation of an animation of a movement of agents, comprises: an interface that receives an agent dataset comprising a position and a velocity for each of a plurality of agents moving on a track presented on a display, wherein the velocity is represented as a vector having a magnitude indicative of speed and a direction, wherein the vector is associated with the position defined using a set of coordinates based on a virtual environment representing the track; a program store storing code; and at least one processor coupled to the interface and the program store for implementing the stored code, the code comprising: code to identify at least one curve of the track, perform for each agent of the plurality of agents: identify neighboring agents of the plurality of agents according to the respective position of each of the plurality of agents, compute a respective inter-agent distance to each of the neighboring agents, adjust at least one of the position and the velocity according to the at least one curve and the distance to each of the neighboring agents; and code to update instructions for rendering a presentation of an animation of a movement of the agents presented on a display according to the adjusted agent dataset that includes the adjusted at least one of the position and velocity of each of the plurality of agents, wherein the performing and the updating are iterated dynamically to provide a realistic animation of the movement of the plurality of agents along the curve of the track.

According to a third aspect, a computer program product comprising a non-transitory computer readable storage medium storing program code thereon for implementation by at least one processor, for computing instructions that update a rendering of a presentation of an animation of a movement of agents, comprises: instructions to receive an agent dataset comprising a position and a velocity for each of a plurality of agents moving on a track presented on a display, wherein the velocity is represented as a vector having a magnitude indicative of speed and a direction, wherein the vector is associated with the position defined using a set of coordinates based on a virtual environment representing the track; instructions to identify at least one curve of the track; instructions to perform, for each agent of the plurality of agents: identify neighboring agents of the plurality of agents according to the respective position of each of the plurality of agents; compute a respective inter-agent distance to each of the neighboring agents; adjust at least one of the position and the velocity according to the at least one curve and the distance to each of the neighboring agents; and instructions to update instructions for rendering a presentation of an animation of a movement of the agents presented on the display according to the adjusted agent dataset that includes the adjusted at least one of the position and velocity of each of the plurality of agents, wherein the performing and the updating are iterated dynamically to provide a realistic animation of the movement of the plurality of agents along the curve of the track.

The systems and/or methods (e.g., code instructions stored in a storage device executable by processor(s)) described herein provide a technical solution to the technical problem of improving the real-life appearance of a presentation of an animation of a movement of agents along a track having at least one curve. In particular, the technical problem may relate to a movement of animals, optionally animals controlled by a human rider (e.g., horse, camel, bull), for example, a betting application in which users bet on the winning horse, and/or animals that travel as a herd (e.g., sheep, birds, fish, and ants). The technical problem may relate to movement of the mammals as a herd around the curve of the track. Generic software frameworks and/or engines provide generic components that may compute movement of agents based on a shortest distance along a navigation mesh. The generic components fail to correctly resemble real-life and/or natural motion of agents moving along a curve of a track, for example, resulting in sharp movements along the curve, unnatural acceleration and/or deceleration of the agent(s), jerky lateral motion along the curve, abnormal formations of agents, and collisions between agents.

In a first possible implementation form of the method or the system or the computer program product according to the first, second, or third aspects, the received agent dataset is received from an interface of a generic platform that computes the agent dataset along a navigation mesh representing the virtual environment based on a shortest distance method, wherein the updated instructions are provided back to the generic platform using the interface for rendering the presentation.

In a second possible implementation form of the method or the system or the computer program product according to the first possible implementation form of the first, second, or third aspects, the adjusting is performed based on longer distances than the shortest distance method used to compute the received agent dataset.

In a third possible implementation form of the method or the system or the computer program product according to any of the previous implementation forms of the first, second, or third aspects, the adjusting the velocity is performed by computing a respective adjustment vector for each agent of the plurality of agents, wherein the updating instructions is performed by adding the respective adjustment vector to the respective velocity of the received dataset for each of the plurality of agents.

In a fourth possible implementation form of the method or the system or the computer program product according to any of the previous implementation forms of the first, second, or third aspects, the adjusting the position is performed by computing a respective set of adjustment values for each agent of the plurality of agents, wherein the updating instructions is performed by adding the respective set of adjustment values to the coordinates of the position within the virtual environment for each of the plurality of agents.

In a fifth possible implementation form of the method or the system or the computer program product according to any of the previous implementation forms of the first, second, or third aspects, the agents comprise horses ridden by jockeys, the movement comprises a race of the horses, and the track comprises a racetrack.

In a sixth possible implementation form of the method or the system or the computer program product according to any of the previous implementation forms of the first, second, or third aspects, the method or the system or the computer program product further comprise: detecting a certain agent of the plurality of agents at a snake position, wherein the certain agent follows movement of another agent located in front of the certain agent; detecting the position of the certain agent relative to the curve of the track; and adjusting at least one of the position and velocity of the certain agent in a direction opposite to the curve.

In a seventh possible implementation form of the method or the system or the computer program product according to the sixth implementation form of the first, second, or third aspects, the method or the system or the computer program product further comprise adjusting the at least one of the position and velocity of the certain agent in the direction opposite to the curve according to the fence-distance between the certain agent and a fence of the track.

In an eighth possible implementation form of the method or the system or the computer program product according to any of the previous implementation forms of the first, second, or third aspects, the method or the system or the computer program product further comprise: detecting the position of a certain agent of the plurality of agents behind a herd of the plurality of agents; and adjusting the direction of the velocity of the certain agent towards approximately the middle of the herd.

In a ninth possible implementation form of the method or the system or the computer program product according to any of the previous implementation forms of the first, second, or third aspects, the method or the system or the computer program product further comprise: detecting that a herd of the plurality of agents are navigating around the curve of the track; adjusting at least one of the position and velocity of each of the plurality of agents of the herd towards the side of the curve.

In a tenth possible implementation form of the method or the system or the computer program product according to the ninth implementation form of the first, second, or third aspects, side of the curve is determined by identifying the relative side of a waypoint of the virtual environment during a change between waypoints relative to at least one of the position and velocity of at least one of the plurality of agents of the herd.

In an eleventh possible implementation form of the method or the system or the computer program product according to the ninth or tenth implementation forms of the first, second, or third aspects, the detecting that the plurality of agents are in the curve is performed by detecting that each agent of the plurality of agents of the herd is navigating the curve by computing the angle between a forward component of the vector of the respective agent and a line formed between the position of the respective agent and a next waypoint of the virtual environment, and analyzing the angle according to an angle curve requirement.

In a twelfth possible implementation form of the method or the system or the computer program product according to the ninth, tenth, or eleventh implementation forms of the first, second, or third aspects, the method or the system or the computer program product further comprise: increasing a curve force vector that points from a certain agent of the plurality of agents of the herd to the side of the curve, when the certain agent is identified as being in a state other than the snake state; and decreasing the curve force vector when the certain agent is identified as being in the snake state.

In a thirteenth possible implementation form of the method or the system or the computer program product according to the ninth, tenth, eleventh, or twelfth implementation forms of the first, second, or third aspects, the method or the system or the computer program product further comprise: computing the fence-distance between each of the plurality of agents of the herd and the fence of the track, and linearly increasing the curve force vector according to the fence-distance.

In a fourteenth possible implementation form of the method or the system or the computer program product according to the ninth, tenth, eleventh, twelfth, or thirteenth implementation forms of the first, second, or third aspects, the method or the system or the computer program product further comprise: detecting when the plurality of agents of the herd are along a straight segment of the track; and adjusting the position of at least one agent of the plurality of agents of the herd located a threshold away from the fence of the track, in a direction opposite from the fence.

In a fifteenth possible implementation form of the method or the system or the computer program product according to any of the previous implementation forms of the first, second, or third aspects, the method or the system or the computer program product further comprise: detecting when a certain agent of the plurality of agents is at a side of the plurality of agents of a herd that is opposite of the side of an upcoming curve; computing the fence-distance between the certain agent and the fence of the side of the curve; and adjusting the velocity of the certain agent towards the side of the curve.

In a sixteenth possible implementation form of the method or the system or the computer program product according to any of the previous implementation forms of the first, second, or third aspects, the adjusting at least one of the position and velocity of each of the plurality of agents is performed according to the number of the plurality of agents.

In a seventeenth possible implementation form of the method or the system or the computer program product according to the sixteenth implementation form of the first, second, or third aspects, the velocity is randomly adjusted for each of the plurality of agents when the number of the plurality of agents is above a threshold.

In an eighteenth possible implementation form of the method or the system or the computer program product according to any of the previous implementation forms of the first, second, or third aspects, the method or the system or the computer program product further comprise: identifying an upcoming curve of the track before the first agent of the plurality of agents of a herd reaches the upcoming curve; adjusting the velocity of at least one agent located towards the front of the plurality of agents of the herd according to a distance relative to approximately the middle of the plurality of agents, by increasing the velocity of each of the at least one agent proportionally to the distance relative to the middle of the plurality of agents of the herd; adjusting the velocity of at least one agent located towards the back of the plurality of agents of the herd according to the distance relative to approximately the middle of the plurality of agents of the herd, by decreasing the velocity of each agent proportionally to the distance relative to approximately the middle of the plurality of agents; identifying that each of the plurality of agents of the herd passed the upcoming curve; and adjusting the velocity of each agent of the plurality of agents of the herd to the velocity prior to the adjusting before the upcoming curve.

In a nineteenth possible implementation form of the method or the system or the computer program product according to any of the previous implementation forms of the first, second, or third aspects, the method or the system or the computer program product further comprise: normalizing the velocity of each of the plurality of agents during navigation of the at least one curve; and linearly interpolating the normalized velocity vector with a forward vector of each of the plurality of agents.

In a twentieth possible implementation form of the method or the system or the computer program product according to any of the previous implementation forms of the first, second, or third aspects, the method or the system or the computer program product further comprise: designating at least one of the plurality of agents as a leader; gradually adjusting the velocity of each respective leader based on a random value to increase the speed of the leader relative to the other agents over the length of the track; and when at least one leader is a distance away from a finish line of track according to a requirement, adjusting at least one of the velocity and position of each respective leader relative to the other agents such that respective leaders reach the finish line according to the designation.

In a twenty-first possible implementation form of the method or the system or the computer program product according to the twentieth implementation form of the first, second, or third aspects, the method or the system or the computer program product further comprise: checking, for each designated leader, whether the respective designated leader is blocked by at least one other agent according to the direction of the velocity vector of the respective designated leader; when the respective designated leader is blocked by the at least one other agent, adjusting the velocity of the designated leading by increasing the magnitude of the speed component of the velocity, adjusting at least one of the position and velocity of the designated leader to one side, adjusting at least one of the position and velocity of the blocking at least one other agent to another side, wherein the respective designated leader passes the blocking at least one other agent.

In a twenty-second possible implementation form of the method or the system or the computer program product according to any of the previous implementation forms of the first, second, or third aspects, the method or the system or the computer program product further comprise: increasing, for each of the plurality of agents, the inter-agent distance between neighboring agents when a distance to the finish line of the track is less than a requirement.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for computing instructions for adjusting a rendering of a presentation of an animation of agents moving along a curve of a track, in accordance with some embodiments of the present invention;

FIG. 2 is a block diagram of components of a system that computes instructions to adjust a rendering of an animation of agents moving along a track, in accordance with some embodiments of the present invention;

FIG. 3 is a flowchart of a method of exemplary additional processing acts for adjusting the position and/or velocity of agents participating in an animation of a movement, in accordance with some embodiments of the present invention;

FIG. 4 is a schematic depicting computation of the angle for identification of the agent navigating a curve, in accordance with some embodiments of the present invention;

FIG. 5 is a schematic depicting neighboring agents, in accordance with some embodiments of the present invention;

FIG. 6 is a schematic depicting stretching of the herd of agents, in accordance with some embodiments of the present invention;

FIG. 7 is a schematic depicting adjustment of the position and/or velocity of an agent in the snake position, in accordance with some embodiments of the present invention; and

FIG. 8 is a schematic depicting adjustment of the velocity and/or position of a designated leading agent, in accordance with some embodiments of the present invention.

### DESCRIPTION OF SPECIFIC EMBODIMENTS OF THE INVENTION

The present invention, in some embodiments thereof, relates to movement of one or more agents along a curve of a track and, more specifically, but not exclusively, to systems and methods for computing instructions to render a presentation of an animation of the agent(s) moving along the track.

An aspect of some embodiments of the present invention relate to systems and/or methods (e.g., code instructions stored in a storage device executable by processor(s)) that compute instructions to update a rendering of an animation of one or more agents moving (e.g., racing, following, going towards a stationary or moving target) along a curve of a track (e.g., a turn of a racetrack) based on the position and/or velocity of the agents relative to one or more curves of the track. The code computes instructions to adjust the animation to animate real and/or natural movement of the agent(s) navigating the curve and/or movement relative to the curve, optionally to animate movement of a herd of agents. Optionally, animation data computed based on shortest distances between locations within the virtual environment (optionally a navigation mesh) is adapted to insert life-like behavior that is based on longer distances than the shortest distances between two or more locations within the virtual environment. The real-life movement obtained based on the adjustment instructions is in contrast to, for example, generic software frameworks that perform computations based on the shortest path and/or velocity for the agent(s) based on frames in which the agent(s) moves between points (e.g., point A and point B), optionally across a navigation mesh. Such generic software frameworks do not accurately animate motion of agents (moving alone and/or within a herd) along a curve of a track, for example, resulting in collisions, jerky motion, sharp movements, abnormal formations of agents, unnatural acceleration and deceleration patterns of the agents, and other un-natural movements. The presentation of the movement (e.g., presented within a GUI on a display) is updated according to the adjusted position and/or velocity of each agent.

The velocity of each agent may be represented as a vector having a magnitude component indicative of speed of the agent, and a direction component indicative of where the agent is headed towards. The position of the agent may be defined as the set of coordinates within a virtual environment (e.g., the navigation mesh) representing the track. The vector may be defined as originating at the position. The adjustment may be computed as an adjustment velocity vector that is added to the current velocity vector of the agent, to create instructions for updating the presentation (i.e., animation) of the agent according to the updated velocity. The adjustment may be computed as an adjustment set of values that are added to the current coordinates defining the position of the agent, to create instructions for updating the presentation of the agent according to the updated position.

Optionally, the agent movement is an animation of a movement of mammal(s), for example, horses, bulls, dogs, and rabbits. Optionally, the agent movement is an animation of a movement of mammals ridden by a human (e.g., jockey), for example, a horse race, a camel race, and a bull race. Optionally, the movement of agents is animated as a herd, by consideration of the relative location between the agents of the herd. The agents may be animals that move together as a herd (i.e., not necessarily mammals), for example, fish, ants, and birds. The animation may be presented as part of a game, for example, an application in which users bet on the winner of the race.

The code instructions determine the relative location of curve(s) of the track relative to one or more of the agents participating in the movement. The position and/or velocity of each agent is adjusted according to the relative location of the respective agent to the curve(s) of the track, and/or relative to the distance between the respective agent and each of the neighboring agents.

Optionally, the adjustment code instructions receive the position and/or velocity by an interface (e.g., application programming interface (API), software development kit (SDK)) of a generic component of a software framework and/or engine designed for creation and development of applications, such as games, for example, the Unity API available from Unity Technologies. The generic engine computes the velocity vector of each of the agents according to the shortest path between two (or more) points defining the location(s) of each agent, for example, between points A and B on the navigation mesh. The generic component may compute the velocity vector for each presented frame for presentation on the display. The adjustment code instructions adjust (as described herein) the velocity vector and/or the position computed by the generic engine, and provide the adjusted velocity vector and/or the adjusted position back to the generic engine for processing and/or rendering of the presentation. The adjustment of the velocity vector and/or position of the agents by the adjustment code instructions make the resulting presentation of the moving agents around a curve appear more natural and life-like.

The systems and/or methods (e.g., code instructions stored in a storage device executable by processor(s)) described herein provide a technical solution to the technical problem of improving the real-life appearance of a presentation of an animation of a movement of agents along a track having at least one curve. In particular, the technical problem may relate to a movement of animals, optionally animals controlled by a human rider (e.g., horse, camel, bull), for example, a betting application in which users bet on the winning horse, and/or animals that travel as a herd (e.g., sheep, birds, fish, and ants). The technical problem may relate to movement of the mammals as a herd around the curve of the track. Generic software frameworks and/or engines provide generic components that may compute movement of agents based on a shortest distance along a navigation mesh. The generic components fail to correctly resemble real-life and/or natural motion of agents moving along a curve of a track, for example, resulting in sharp movements along the curve, unnatural acceleration and/or deceleration of the agent(s), jerky lateral motion along the curve, abnormal formations of agents, and collisions between agents.

The systems and/or methods (e.g., code instructions stored in a storage device executable by processor(s)) described herein improve an underlying technical process within the technical field of navigation of agents within a virtual environment, for example, along a navigation mesh.

The systems and/or methods (e.g., code instructions stored in a storage device executable by processor(s)) described herein improve performance of a computing unit that is used to compute position and/or velocity of agents for rendering of a presentation of an animation of a movement of the agent. The systems and/or methods improve the functioning of the basic display function of the computer itself, optionally by improving the resultant computed vectors for rendering and presenting the animation of the agents during the movement. The computed velocity vectors and/or positions may be an improved adjustment of velocity vectors and/or positions computed by generic components of a generic engine.

The systems and/or methods (e.g., code instructions stored in a storage device executable by processor(s)) described herein improve performance of a computing unit that computes position and/or velocity of agents for rendering of a presentation of an animation of a movement of the agent. The computation of the adjustment of the position and/or velocity of the moving agents along a curve of the track may improve the performance of existing available memory and/or computational resources, by improving the resulting rendered animation.

The systems and/or methods (e.g., code instructions stored in a storage device executable by processor(s)) described herein tie mathematical operations (e.g., computation of the adjustment of the position and/or velocity of the moving agents) to the ability of processor(s) to execute code instructions.

The systems and/or methods (e.g., code instructions stored in a storage device executable by processor(s)) described herein provide a unique, particular, and advanced technique of processing position and/or velocity of agents in a virtual environment to compute realist and/or natural motion of the moving agents along a curve of a track.

Accordingly, the systems and/or methods described herein are necessarily rooted in computer technology to overcome an actual technical problem arising in the technical field of computing an animation of movement of agents in a virtual environment.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As used herein, the term herd means a group of agents moving in proximity to one another. The herd does not necessarily include all of the moving agents. Outlier agents are not necessarily included within the herd. It is noted that the term herd as used herein applies to any type of agent, not necessarily hoofed mammals, for example, herd as used herein applies to birds, fish, dogs, and ants.

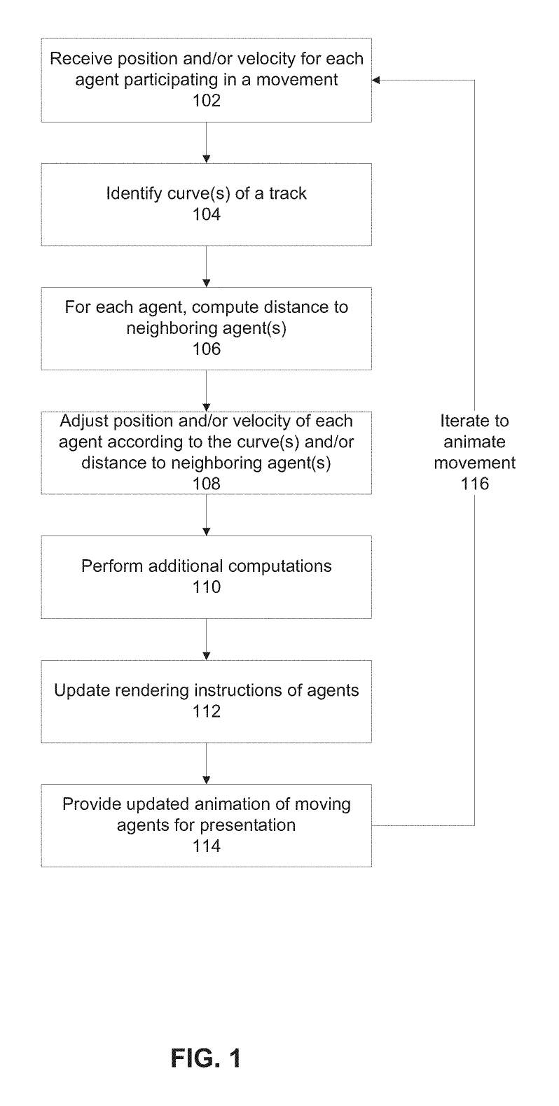

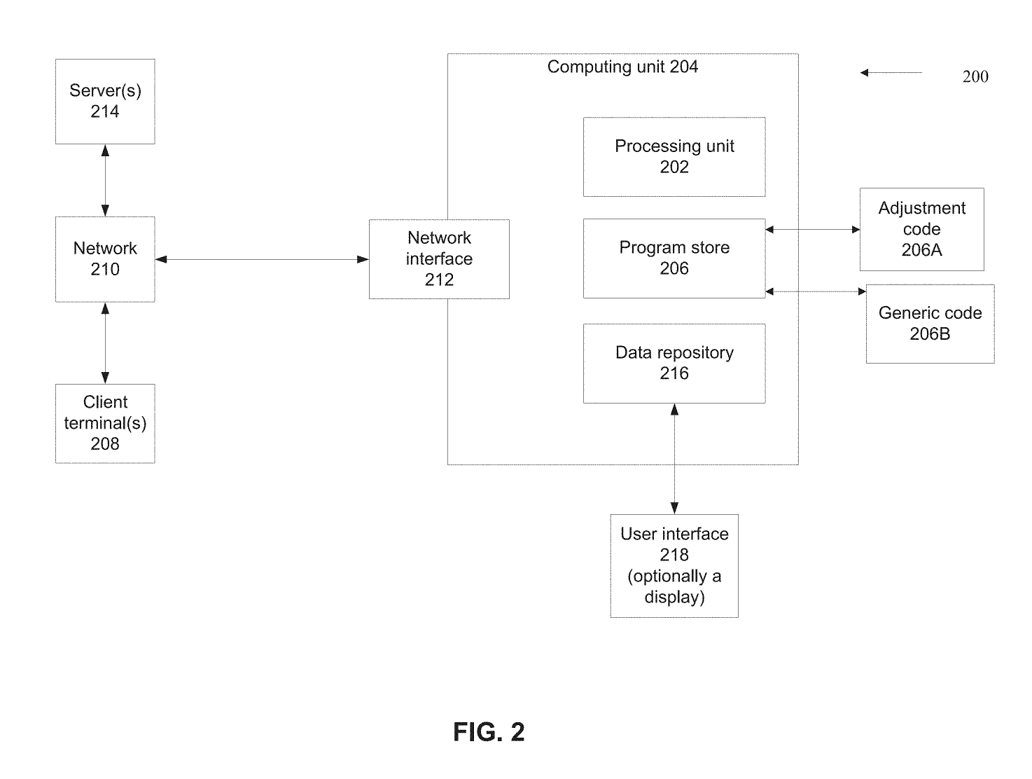

Reference is now made to FIG. 1, which is a flowchart of a method for computing instructions for adjusting a rendering of a presentation of an animation of agents moving along a curve of a track, in accordance with some embodiments of the present invention. Reference is also made to FIG. 2, which is a block diagram of components of a system 200 that computes instructions to adjust a rendering of an animation of agents moving along a track, in accordance with some embodiments of the present invention. System 200 may execute one or more acts of the method described with reference to FIG. 1, for example, by a processing unit 202 of a computing unit 204 executing code instructions stored in a program store 206.

Computing unit 204 may be implemented as, for example, a client terminal, a server, a web server, a computing cloud, a mobile device, a desktop computer, a thin client, a Smartphone, a Tablet computer, a laptop computer, a wearable computer, glasses computer, and a watch computer.

Computing unit 204 may include locally stored software that performs one or more of the acts described with reference to FIG. 1, and/or may act as one or more servers (e.g., network server, web server, a computing cloud) that provides services (e.g., one or more of the acts described with reference to FIG. 1) to one or more client terminals 208. Different architectures may be implemented based on system 200, and/or for execution of the acts described with reference to the method of FIG. 1. In an exemplary implementation, computing unit 204 acts as a server, optionally a web server. The server may provide software as a service (SAAS) to one or more client terminals 208 over a network 210 using a network interface 212. The server may provide a remote access session to client terminals 208, for example, using a web browser to access a web page hosted by the server implementation of computing unit 204. The server may provide an application, code instructions, and/or a software interface, for local download to client terminals 208. In another exemplary implementation, computing unit 204 acts a client terminal communicating with a server 214, optionally a web server. Server 214 may provide an application and/or code instructions for download and installation on computing unit 204. Server 214 may be accessed by computing unit 204, for example, by applications installed on computing unit 204 that remotely access server 214, for example, by a web browser or other application. In yet another exemplary implementation, computing unit 204 may be a standalone device executing remotely installed code.

Processing unit(s) 202 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processing unit(s) 202 may include one or more processors (homogenous or heterogeneous), which may be arranged for parallel processing, as clusters and/or as one or more multi core processing units.

Program store 206 stores code instructions implementable by processing unit 202, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Program store 206 may store code instructions that when executed by processing unit 202, implement one or more acts of the method described with reference to FIG. 1.

Computing unit 204 may include a data repository 216 for storing data. Data repository 216 may be implemented as, for example, a memory, a local hard-drive, a removable storage unit, an optical disk, a storage device, and/or as a remote server and/or computing cloud (e.g., accessed using a network connection). It is noted that code instructions executable by processing unit 202 may be stored in data repository 216, for example, with executing portions loaded into program store 206 for execution by processing unit 202.

Program store 206 and/or data repository 216 (and/or storage devices associated with server 214 and/or client terminals 208) may store the adjustment code 206A that computes the adjusted position and/or vector of the agents (as described herein), and/or the generic component(s) 206B that computing the baseline position and/or vector that may be adjusted by adjustment code 206A.

Network interface 212 that connects to network 210 may be implemented as, for example, one or more of, a network interface card, a wireless interface to connect to a wireless network, a physical interface for connecting to a cable for network connectivity, a virtual interface implemented in software, network communication software providing higher layers of network connectivity, and/or other implementations. Computing unit 204 may access one or more remote servers 214 using network 210, for example, to download the adjustment code 206A and/or generic components 206B, and/or to provide the adjustment code 206A and/or generic components 206B for download by client terminals 208.

Computing unit 204 includes or is in communication with one or more user interfaces 218 designed for a user to enter data and/or view presented data and/or view the rendered animation of the moving agents. Exemplary user interfaces 218 include, for example, one or more of, a touchscreen, a display, a keyboard, a mouse, and voice activated software using speakers and microphone.

The acts of the method described with reference to FIG. 1 may be stored as program code instructions in program store 206, executable by processing unit 202 of computing unit 204.

At 102, position and/or velocity are received for each agent participating in a movement on a track presented on a display (e.g., display 218), optionally within a GUI, for example, within a gambling and/or gaming application in which users bet on the outcome of the movement.

Exemplary movements include: racing of the agents (e.g., from a start line towards a finish line), agents following a moving target, agents moving towards a stationary target, agents moving away from a stationary or moving target, and agents moving along the path without necessarily moving towards or away from a defined target.

Exemplary tracks include: a racetrack, simulation of a natural landscape (e.g., twists and turns along a valley between cliffs, a road within a forest), a virtual track defining limits of movement of the agents (e.g., the limits are not presented in the animation to the user).

Exemplary animation scenarios include: a horse race, a herd of zebras being chased along a dirt road by a lion, a herd of dogs casing a cat, a herd of fish swimming along a coral reef, and a herd of birds flying in the air between buildings.

The position may be implemented, for example, as a current position within a virtual environment of the track, coordinates on the screen, relative position (e.g., distance) to a reference, or other representations.

The velocity may be implemented, for example, as a vector (optionally with origin at the respective position) with magnitude component of speed and direction component of the moving agent.

The position and/or velocity may be stored in a data structure storing the position and/or velocity for the agents, for example, a dataset, a set of records, a matrix, a table, or other implementations.

The position and/or velocity may be received from generic component 206B, representing a baseline position and/or velocity computed based on the methods implemented by the generic engine. The position and/or velocity are adjusted by adjustment code 206A.

At 104, one or more curves of the track are identified. Optionally, the identified curve is being navigated by one or more horses (i.e., the horses are turning around the curve). Alternatively or additionally, the identified curve is upcoming (i.e., horses have not yet reached the curve).

Optionally, the side of the curve relative to each horse is identified. The curve may be a curve towards the left side or towards the right side of the horse(s).

The curve may include a turn of the track, for example, at least about 10 degrees, or at least about 30, 45, 60, 90, 180, 270, and 360 degrees, or ranges thereof, or other intermediate values thereof.

The curve side may be calculated globally, or per agent, or per group of agents (e.g., the herd of agents). The curve side may be computed based on the direction of the agent (e.g., derived from the velocity) and waypoint positions. The waypoints may be designated positions defined within the track virtual environment. Waypoints may be defined along the track, optionally on one side of the track, options spaced apart approximately with equal spacing between waypoints.

The side of the curve may be detected by identification of the side of the waypoint point relative to the agent during a change between waypoints relative to the position and/or velocity of one or more of the agents. When one or more agents pass a certain waypoint (e.g., the agent in the lead, and/or performed for each agent passing past a waypoint) the side of the waypoint relative to the agent is identified.

Optionally, an analysis is conducted to identify when each agent, or the herd of agents, is navigating the curve. The detecting that one or more agents are in the curve may be performed by computing the angle between a forward component of the velocity vector of the respective agent and a line formed between the position of the agent and the next waypoint. The value of the angle is analyzed according to an angle curve requirement, for example, a threshold, a function, and a range. For example, an angle above a threshold of 30 degrees may be indicative that the agent is navigating the curve. The threshold may be selected based on the maximum angle that would be obtained from the agent to the next waypoint along a straight track. An angle higher than the threshold is indicative of the curve.

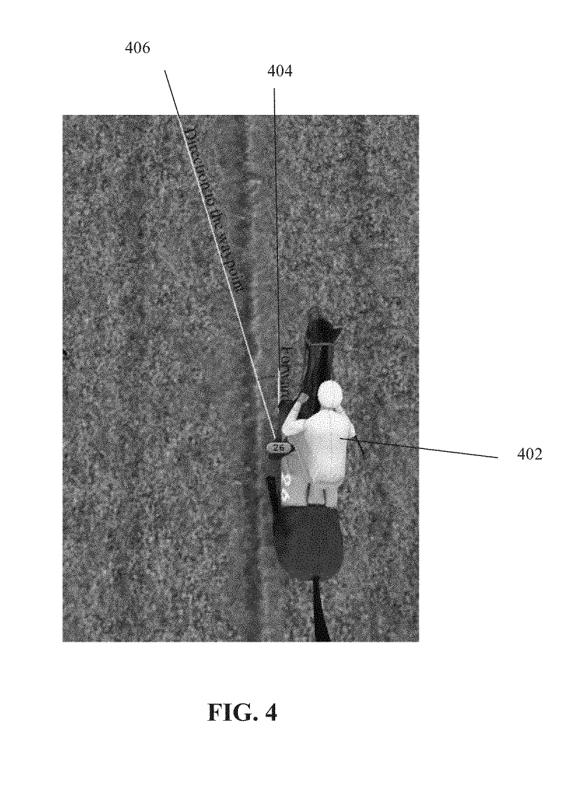

Reference is now made to FIG. 4, which is a schematic depicting computation of the angle for identification of the agent navigating a curve, in accordance with some embodiments of the present invention. A moving agent 402 (e.g., race horse ridden by a jockey) is associated with a forward component of the velocity vector 404. Line 406 denotes the direction from agent 402 to the next waypoint.

Optionally, the identification of the upcoming curve (i.e., before one or more agents reach and navigate the curve) may be performed by computing the angle to the next waypoint after the upcoming waypoint, to the waypoint located two waypoints further than the upcoming waypoint, and to additional further waypoints. Each waypoint may be associated with a requirement to indicate whether the respective waypoint is associated with a curve.

At 106, the distance to each of the neighboring agents of each of the moving agents is computed. The neighbors influence the position and/or velocity of one another.

For each agent participating in the movement, the neighboring agents are identified. The nearest unobstructed agents are designated as agents. The neighboring agents may be identified based on straight lines drawn from the agent towards the other agents (e.g., towards the position of each agent, and/or towards the beginning and end of each agent). The further located agents having lines overlapping with lines of closer agents may be excluded as neighbors. The distance to each of the neighboring agents is computed.

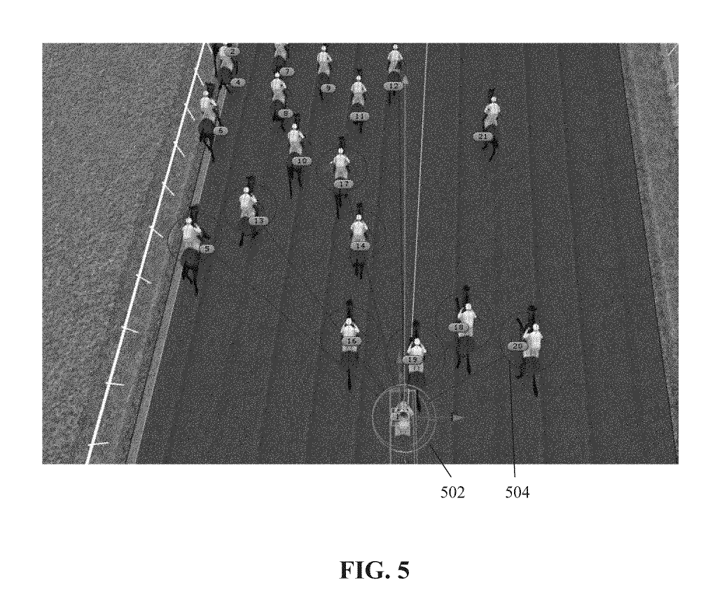

Reference is now made to FIG. 5, which is a schematic depicting neighboring agents, in accordance with some embodiments of the present invention. Neighboring agents are identified for agent 502. Neighboring agents are marked with a circle 504. Lines connecting neighbors with agent 502 may be used to exclude obstructed agents as neighbors. For example, horses labeled 5, 13, 17, 14, 16, 19, 18, and 20 are identified as neighbors. Horses labeled 2, 4, 6, 7, 8, 10, 9, 11, 12, and 21 are not labeled as neighbors, due to obstruction by one or more of the identified neighbors (e.g., based on the lines connecting each horse with agent 502).

At 108, the position and/or the velocity of one or more agents are adjusted according to the identified curve and/or according to the distance to each of the neighboring agents. The adjustment may be performed independently for each agent, and/or globally for one or more agents (e.g., all agents, agents within the herd). The adjustment may be performed to display behavior of a herd of agents, rather than behavior of independent agents. It is noted that all agents are not necessarily included in the herd, for example, agents in the lead, in the rear, and/or off to the side may not necessarily be included in the behavior of the herd (e.g., since the distance of the agent to the herd may reduce the herd effect for the agent).

The adjustment may be performed by computation of an adjustment vector. The adjustment vector may be added to the received vector (i.e., as described with reference to block 102). The position may be adjusted by computation of adjustment position values that are added to shift the coordinates of the agent within the virtual environment.

Adjustment based on velocity is sometimes referred to as alignment. Adjustment based on position is sometimes referred to as cohesion.

Optionally, the position and/or velocity of the agents is adjusted according to the number of the agents participating in the movement. Adjustment based on the number of agents participating in the movement improves the appearance of the movement animation, for example, similar adjustments made to 30 moving horses and to 7 moving horses may appear natural to the 30 horses and abnormal to the 7 moving horses. The adjustment vector (that is added to the received vector) is computed according to the number of agents, for example, according to a function, which may be non-linear. Optionally, the velocity (e.g., velocity vector) is randomly adjusted for each agent according to a requirement based on the total number of agents participating in the movement, for example, a threshold, a function, and/or a range. For example, when there are many agents participating in the movement (e.g., above a threshold of 25), the velocity vector of each agent is randomly adjusted. The random adjustment reduces or prevents the agents falling into soldier formation (also termed soldier behavior) in which the agents are organized into parallel rows, similar to marching soldiers. When the number of agents participating in the movement is large (e.g., above the threshold), agents located towards the middle of the herd tend to get stuck, due to blockage by neighboring agents on all sides. The blocking may otherwise (i.e., without the random adjustment) result in the soldier formation. When the number of agents participating in the movement is small (e.g., below the requirement), the agents located towards the middle of the herd are not blocked on all sides, which prevents or reduces soldier formation.

Optionally, the computation of the adjustment velocity vector is based on a function of the number of agents. The function may be defined as a table of value that map number of agents to a velocity adjustment. The function may be computed based on an interpolation between two or more defined points denoting exemplar number of agents.

Optionally, when the agents (optionally of the herd) are navigating around the curve of the track, the position and/or velocity of each of the agents navigating the curve is shifted towards the curve side.

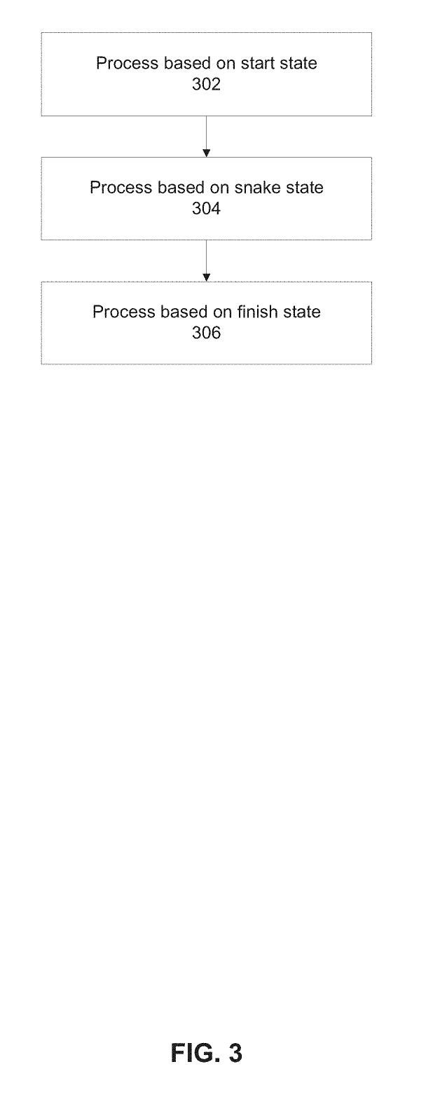

Optionally, when one or more agents are detected as not being in the snake position the respective values of the curve force vectors are increased towards the side of the detected curve. When the one or more agents are detect as being in the snake position, the respective values of the curve force vectors are decreased. Detection of the snake position is described with reference to block 304 of FIG. 3. The curve force vector is defined as a vector that points from the agent towards the side of the curve. When the curve is represented as an arc of a circle, the curve force vector may point towards the center of the circle. The curve force vector may be a component of the velocity vector, and/or added to the velocity vector of each agent.

Optionally, the value of the increase of the curve force vector is adjusted according to a computed fence-distance between each respective agent and the fence (or other edge representation) of the track. Optionally, the value of the curve force linearly increases with increasing fence-distance (other scales may be used, for example, exponential, logarithmic, and custom defined).

Optionally, when a gap is detected in proximity to the fence (or other edge representation) of the track, the position and/or velocity of an agent in proximity to the gap is adjusted to insert the agent into the gap when the size of the gap is large enough to accommodate the agent.

Optionally, when one or more agents (optionally the herd of agents) are detected as not navigating the curve, the position and/or velocity of the one or more agents is adjusted towards the fence, to reduce the fence-distance between each agent and the fence. The adjustment is performed towards the side of the upcoming curve. The adjustment based on the upcoming curve animates control of the agent by a human aware of the side of the upcoming curve, for example, a jockey riding a horse. The adjustment may be performed for the agents that are located on the side of the herd that is opposite the upcoming curve (e.g., for agents located on the right side of the herd when the upcoming curve is a left curve). The adjustment may be performed for agents located a value of the fence-distance above a requirement (e.g., threshold). The reduced fence-distance (when the upcoming curve is reached and navigated) reduces the length of the path that the respective agent moves on. For example, for a left curve, the path length is shorter along the left side of the track than in the middle of the track. Agents having the value of the fence-distance below the requirement may not necessarily be adjusted, and/or may be adjusted in a direction opposite to the direction of the curve (i.e., away from the fence by increasing the fence-distance). The movement away from the fence may generate a random movement that appears realistic to the viewer. The adjustment towards and/or away from the fence may be performed when the herd of agents is wide (e.g., based on a requirement, for example, a threshold, a function, a range) indicative of space between agents large enough so that agents can move around or move closes to one another.

Optionally, the herd of agents is stretched prior before the leading agent(s) of reaches the upcoming curve. The stretching improves the realistic nature of the animation of the movement, by increasing the ability of the agents to move towards the fence during navigation of the curve, to reduce the length of the path that each agent travels during the curve. Agents towards the front are speeded up, while agents towards the back are slowed down. Optionally, the adjustment is performed by adjusting the velocity of each agent relative to the center of the herd is determined. The center of the herd may be computed, for example, based on an equal number of agents before and after an imaginary line perpendicular to the direction of the track, based on a geometric center of mass computed for the herd, or other implementations. The velocity of each agent may be adjusted proportionally to the distance of each respective agent from the computed center of the herd. The velocity of agents ahead of the center is increased, and the velocity of agents behind the center is decreased.

Optionally, the velocity adjustment is reversed when the herd (or each agent) completes navigation of the curve. Each of the agents is identified as having passed the curve (i.e., the upcoming curve for which the adjustment is made). The velocity of each agent is adjusted back to the velocity prior to the adjustment made before the agents reached the curve.

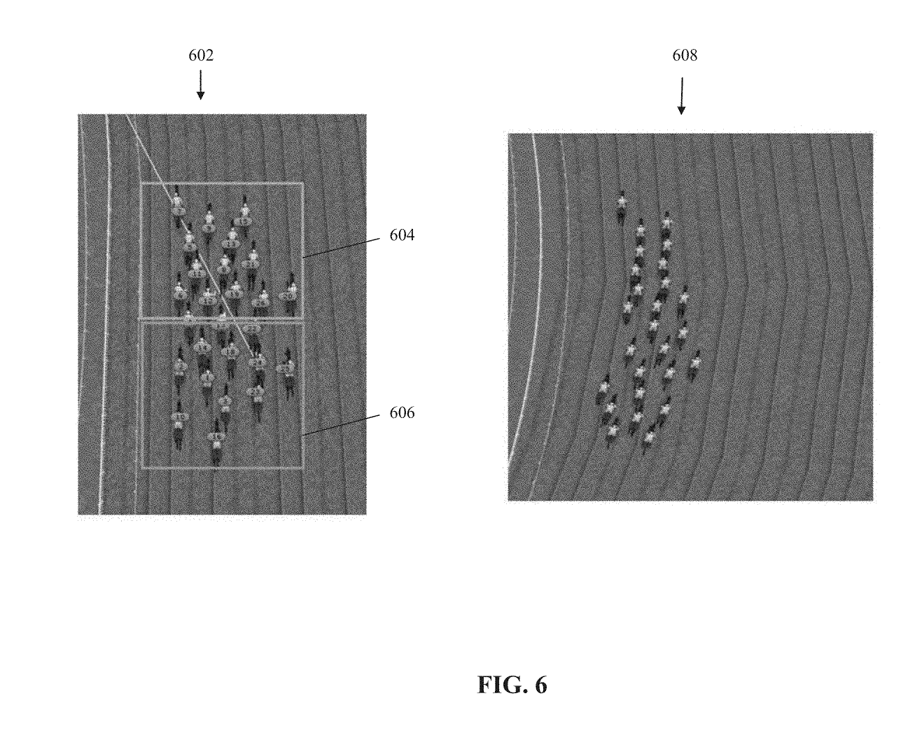

Reference is now made to FIG. 6, which is a schematic depicting stretching of the herd of agents, in accordance with some embodiments of the present invention. Image 602 depicts a herd of horses prior to reaching and navigating an upcoming curve of the track. Box 604 denotes horses located forward of the center of the herd. The velocity (i.e., speed component of the velocity vector) of each of the horses in box 604 is increased. Box 606 denotes horses located to the back of the center of the herd. The velocity of each of the horses in box 606 is decreased. The increase and decrease in velocity is proportional to the distance of each respective horse to the center of the herd. The center is denoted by the line(s) forming the border between boxes 604 and 606. Image 608 represents the stretched herd navigating the curve.

Optionally, the velocity of each agent is normalized. The velocity may be normalized when the agent(s) are navigating the curve. The normalization smoothes out sharp velocities. The normalized velocity vector may be linearly interpolated (also termed lerped) with the forward vector component of the velocity of each agent. The normalized velocity may be lerped with the forward vector by multiplying the normalized velocity with the speed of each agent to obtain the adjusted velocity.

Optionally, rotation computations performed by generic components 206B are disabled, optionally based on instruction code issued by adjustment code 206A. For example, navmesh rotation is disabled. Computation of rotation instructions are provided by adjustment code 206A. Adjustment code 206A computes the rotation instructions as the instructions to adjust the velocity and/or position of the agent to smooth away the effect of sharp turning of the agents along the curve that is outputted by generic component 206B. Adjustment code 206A may analyze the received velocity for sharpness of a turn (e.g., turning angle according to a curve requirement, such as a threshold). Turns of the agent identified as too sharp (based on the curve requirement) may be smoothed by computation of a forward adjustment velocity vector that is added to the received velocity vector.

The received speed component of the velocity vector (i.e., as described with reference to block 102) may be based on speed graphs, for example, obtained by empirical data, a mathematical model, or other methods. Additional variables may be used to compute the adjustment of the speed component of the velocity vector. The additional variables may improve fine control over the speed of the agents, stretching of the herd (as described herein), race winner order correction, and for a straight competition towards the finish line. Each variable may be independently set, disabled, or zeroed.

The adjustment to the speed component of the velocity of each agent is computed to occur gradually, in relatively small increments. The gradual adjustment prevents the appearance of abnormal rocket-like horses that suddenly accelerate. The value of the maximum speed clamp may be decreased, which prevents the rocket-like horses.

Optionally, at 110, additional processing is performed. The additional processing may be implemented before, after, and/or in association (e.g., simultaneously, during, incorporated with) the adjustment of the position and/or vector described with reference to block 108.

Reference is now made to FIG. 3, which is a flowchart of a method of exemplary additional processing acts for adjusting the position and/or velocity of agents participating in an animation of a movement, in accordance with some embodiments of the present invention. The acts of the method described with reference to FIG. 3 may be stored as program code instructions in program store 206, executable by processing unit 202 of computing unit 204.

At 302, one or more of the agents may be designated as a leader that will lead the movement, for example, win the race, or first reach a target. It is noted that there may be several leaders, for example, designated to win first, second, and third places. The speed component of the velocity of each designated leader is randomly adjusted throughout the movement. The random adjustment may slow down the leader(s), have the leader lead from the start of the movement (rare scenario), or run at the tail. The random adjustment creates a realistic animation of the behavior of the leader(s) during the movement.

The speed component of the velocity of each leader is gradually adjusted during the movement (e.g., as the leader moves from the start to the finish line) based on the random value, to increase the speed of the leader relative to the other agents over the length of the track. The rate of increase of the speed is related to the length of the track. The increase in speed of the designated leader is selected to place the designated leader in the lead position, even when the designated leader started very slow.

When the leader(s) are identified as having the position of in front of or at the head of the herd of agents, the adjustment of the velocity and/or position of the leaders is performed to animate competition according to a predefined scenario, and/or the leaders are sped up.

When the leader(s) are identified as having the position of approximately in the middle of the herd of agents, the adjustment of the velocity and/or position of the leaders is performed to speed up the leader(s).

When the leader is a finish-distance away from the finish line (according to a requirement, for example, a threshold) an analysis is performed to identify whether the leader(s) is further from the finish line than the neighboring agents (i.e., the leader is behind one or more agents), or whether the neighboring agents are behind the leader(s)). The velocity and/or position of the leader(s) is adjusted relative to the other agents such that each leader reaches the finish line according to the designation (e.g., first place, second place, and third place).

The position of the leader(s) is analyzed relative to neighboring agents to prevent collisions with the neighbors. Collisions, which are undesired behavior of moving agents, may be computed by generic component 206B, for example, by the navagent collider code of the Unity API platform. Adjustment code 206A prevents collisions between agents, optionally between the leader(s) and neighboring agents. The collision is prevented by checking whether the leader(s) is blocked by one or more agents. Blocking agents may be identified based on the direction component of the velocity vector. The direction component of the velocity vector may be followed by adjustment code 206A to determine whether there are agents intersecting the path of the velocity vector.

When the leader(s) is identified as being blocked by one or more other agents, the velocity and/or position of the leader is adjusted by increasing the speed and moving the agent to one side. The velocity and/or position of the blocking agent is adjusted to the opposite site. The adjustments prevent a collision between the leader and the blocking agent when the leader passes the blocking agent.

When there are multiple leaders that are not blocked by other agents, the leaders may compete with each other. The adjustments of the velocity and/or position of the leaders is performed to animate the competition with one another, for example, by increasing the speed of the leader(s), having the leaders run nose to nose, or having the designated second place agent temporarily outrun the designated first place agent. The competition is implemented until the leaders are within a finish-distance of the finish line (e.g., according to a requirement, such as a threshold). When the finish-distance is reached, the velocity and/or position of the designated first place agent is adjusted to win the race by being the first to cross the finish line.

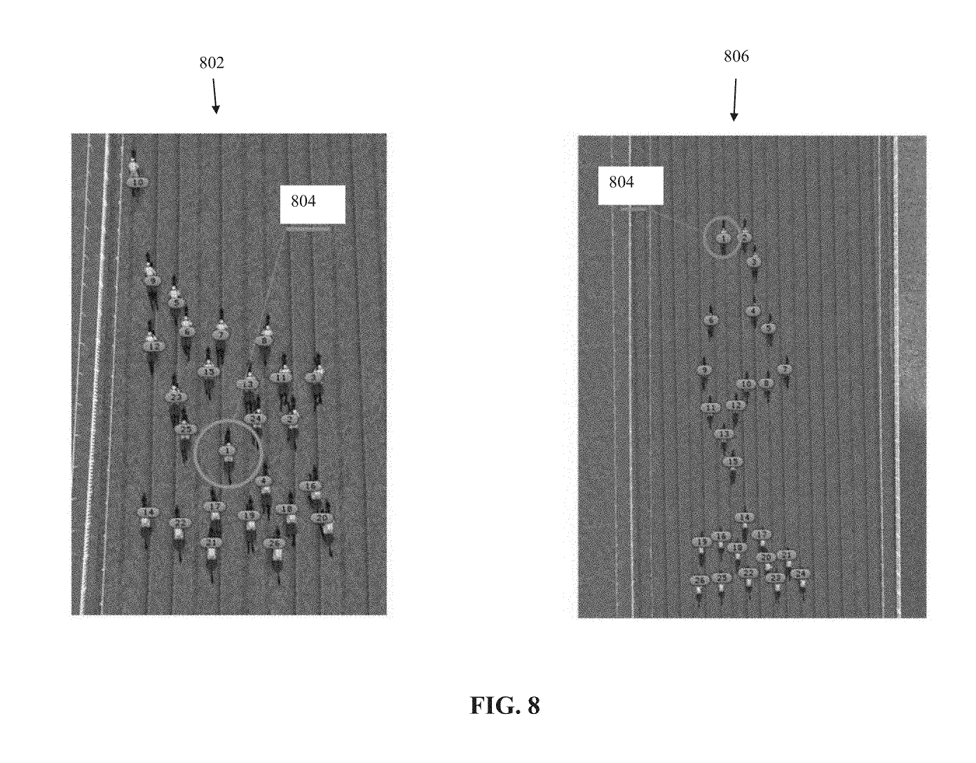

Reference is now made to FIG. 8, which is a schematic depicting adjustment of the velocity and/or position of a designated leading agent, in accordance with some embodiments of the present invention. Image 802 depicts a designated leader agent 804 that is designated to lead the movement, for example, win the race. Leader 804 is located approximately within the middle of the herd. Image 806 depicts leader 804 at the front of the herd when leader 804 is close to the finish line. Leader 804 wins the race. The adjustment of the velocity and/or position of leader 804 between images 802 and 806 is performed as described herein.

At 304, one or more agents are detected as being in a snake position. The snake position is identified when one or more agents follow the movements of a leading agent. For example, when the leading agent moves left, and then right, the agents in snake position follow the left and right moves behind the leading agent.

Optionally, the position and/or velocity of agent(s) identified as being in the snake position are shifted in the direction opposite to the curve direction (i.e., when the agent(s)) are navigating the curve. The curve direction is detected as described herein with reference to block 104 of FIG. 1. Alternatively or additionally, the position and/or velocity of the agent(s) identified as being in the snake position are adjusted according to the computed fence-distance (i.e., the distance between the certain agent and the fence (or other border) of the track). The position and/or velocity of the agent(s) are adjusted in the direction opposite to the curve according to the fence-distance. The magnitude of adjustment may be inversely related to the fence-distance. For example, when agent(s) are turning left and are identified as being in the snake position near the fence (e.g., fence-distance below a threshold), one or more of the agents may be adjusted towards the right. Agents located far from the fence (e.g., fence-distance above the requirement) may be adjusted with a lower magnitude, or not adjusted at all, while agents close to the fence may be adjusted with a higher magnitude.

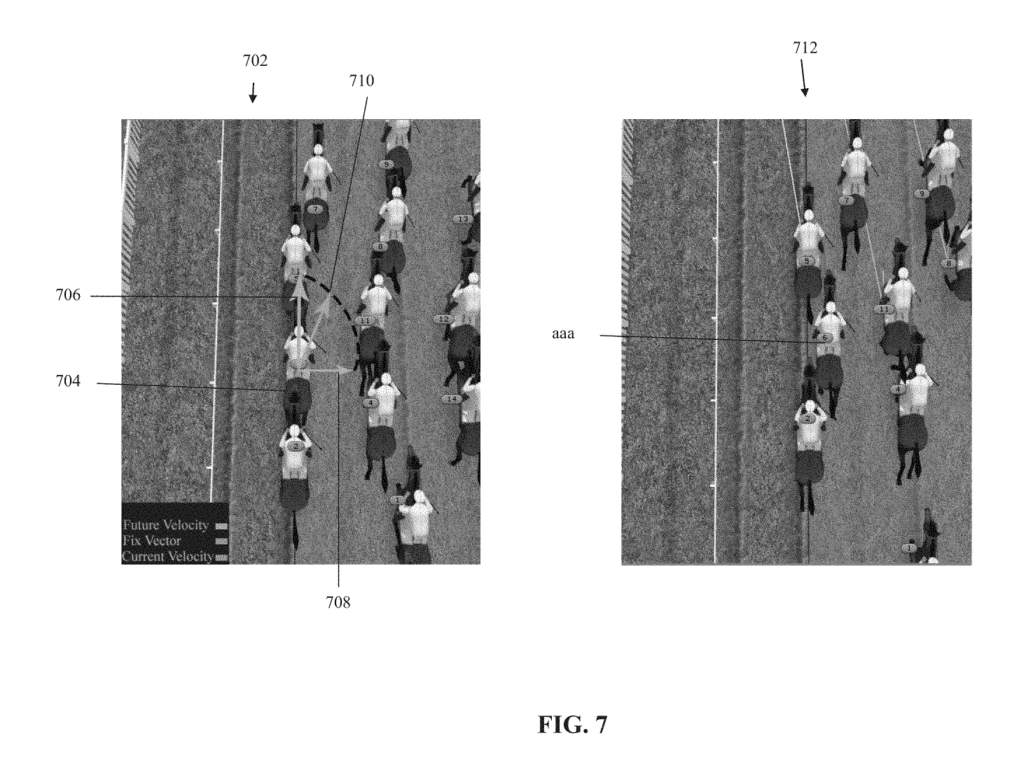

Reference is now made to FIG. 7, which is a schematic depicting adjustment of the position and/or velocity of an agent in the snake position, in accordance with some embodiments of the present invention. Image 702 depicts a horse 704 agent in the snake position. Arrow 706 represents the current velocity of horse 704. Arrow 708 represents the computed adjustment vector to correct the velocity of horse 704. Arrow 710 represents the resulting vector calculated based on the addition of the adjustment vector 708 to the current velocity vector 706. Image 712 represents an update of image 702 based on the resulting vector 710 applied to horse 702, in which horse 702 is removed from the snake position.

At 306, the position of agent(s) is identified as being behind the herd of agents. The agent(s) may not necessarily be last. The herd of agents may include all of the agent(s), or a group of agents close together, running together.

The velocity vector of the identified agent is adjusted towards the center of the herd. The agent with the adjusted velocity vector moves towards the center of the herd.

At 308, the finish line of the movement (e.g., race) may be detected. The finish-distance, defined herein as the distance of each of the agents, and/or of the herd as a whole, to the finish line is computed. The position and/or velocity of each agent is adjusted to maintain the agents relatively close together as a herd when the finish-distance denotes a large distance to the finish line (e.g., cohesion), for example, above a threshold or other requirement. When the finish-distance is below the threshold, indicating that the agent(s) are close to the finish line, the position and/or velocity of the agent(s) is adjusted to spread the agents along the track, by increasing the inter-agent distance between neighboring agents (e.g., separation behavior).

Referring now back to FIG. 1, at 112, the instructions for rendering the animation of the movement are updated according to the adjusted position and/or velocity of each of the agents. The adjusted position and/or velocity may be provided to generic component 206B by adjustment code 206A, for example, using the API of the generic engine. The updated instructions may be computed by generic component 206B based on the adjusted position and/or velocity.

At 114, the updated animation is rendered based on the updated instructions. The animation of the moving agents based on the updated instructions may be presented within the GUI, for example, within an application presenting the movement on a display of a Smartphone, within a web browser of a client terminal accessing a server, and/or other implementations.

At 116, one or more blocks 102-112 are iterated dynamically to animate the movement of the agents along the track, including the curve(s) of the track.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant generic code and/or platforms will be developed and the scope of the term generic code and/or platform is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method for computing instructions that update a rendering of a presentation of an animation of a movement of agents, comprising:
receiving an agent dataset comprising a position and a velocity for each of a plurality of agents moving on a track presented on a display, wherein the velocity is represented as a vector having a magnitude indicative of speed and a direction, wherein the vector is associated with the position defined using a set of coordinates based on a virtual environment representing the track;
identifying at least one curve of the track;
performing, for each agent of the plurality of agents:
identifying neighboring agents of the plurality of agents according to the respective position of each of the plurality of agents;
computing a respective inter-agent distance to each of the neighboring agents;
adjusting at least one of the position and the velocity according to the at least one curve and the distance to each of the neighboring agents; and
updating instructions for rendering a presentation of an animation of a movement of the agents presented on the display according to the adjusted agent dataset that includes the adjusted at least one of the position and velocity of each of the plurality of agents,
wherein the performing and the updating are iterated dynamically to provide a realistic animation of the movement of the plurality of agents along the curve of the track.

2. The method of claim 1, wherein the received agent dataset is received from an interface of a generic platform that computes the agent dataset along a navigation mesh representing the virtual environment based on a shortest distance method, wherein the updated instructions are provided back to the generic platform using the interface for rendering the presentation.

3. The method of claim 2, wherein the adjusting is performed based on longer distances than the shortest distance method used to compute the received agent dataset.

4. The method of claim 1, wherein the adjusting the velocity is performed by computing a respective adjustment vector for each agent of the plurality of agents, wherein the updating instructions is performed by adding the respective adjustment vector to the respective velocity of the received dataset for each of the plurality of agents.

5. The method of claim 1, wherein the adjusting the position is performed by computing a respective set of adjustment values for each agent of the plurality of agents, wherein the updating instructions is performed by adding the respective set of adjustment values to the coordinates of the position within the virtual environment for each of the plurality of agents.

6. The method of claim 1, wherein the agents comprise horses ridden by jockeys, the movement comprises a race of the horses, and the track comprises a racetrack.

7. The method of claim 1, further comprising:
detecting a certain agent of the plurality of agents at a snake position, wherein the certain agent follows movement of another agent located in front of the certain agent;
detecting the position of the certain agent relative to the curve of the track; and
adjusting at least one of the position and velocity of the certain agent in a direction opposite to the curve.

8. The method of claim 7, further comprising adjusting the at least one of the position and velocity of the certain agent in the direction opposite to the curve according to the fence-distance between the certain agent and a fence of the track.

9. The method of claim 1, further comprising:
detecting the position of a certain agent of the plurality of agents behind a herd of the plurality of agents; and
adjusting the direction of the velocity of the certain agent towards approximately the middle of the herd.

10. The method of claim 1, further comprising:
detecting that a herd of the plurality of agents are navigating around the curve of the track;
adjusting at least one of the position and velocity of each of the plurality of agents of the herd towards the side of the curve.

11. The method of claim 10, wherein the side of the curve is determined by identifying the relative side of a waypoint of the virtual environment during a change between waypoints relative to at least one of the position and velocity of at least one of the plurality of agents of the herd.

12. The method of claim 10, wherein the detecting that the plurality of agents are in the curve is performed by detecting that each agent of the plurality of agents of the herd is navigating the curve by computing the angle between a forward component of the vector of the respective agent and a line formed between the position of the respective agent and a next waypoint of the virtual environment, and analyzing the angle according to an angle curve requirement.

13. The method of claim 10, further comprising:
increasing a curve force vector that points from a certain agent of the plurality of agents of the herd to the side of the curve, when the certain agent is identified as being in a state other than the snake state; and
decreasing the curve force vector when the certain agent is identified as being in the snake state.

14. The method of claim 10, further comprising:
computing the fence-distance between each of the plurality of agents of the herd and the fence of the track, and linearly increasing the curve force vector according to the fence-distance.

15. The method of claim 10, further comprising:
detecting when the plurality of agents of the herd are along a straight segment of the track; and
adjusting the position of at least one agent of the plurality of agents of the herd located a threshold away from the fence of the track, in a direction opposite from the fence.

16. The method of claim 1, further comprising:
detecting when a certain agent of the plurality of agents is at a side of the plurality of agents of a herd that is opposite of the side of an upcoming curve;
computing the fence-distance between the certain agent and the fence of the side of the curve; and
adjusting the velocity of the certain agent towards the side of the curve.

17. The method of claim 1, wherein the adjusting at least one of the position and velocity of each of the plurality of agents is performed according to the number of the plurality of agents.

18. The method of claim 17, wherein the velocity is randomly adjusted for each of the plurality of agents when the number of the plurality of agents is above a threshold.

19. The method of claim 1, further comprising:
identifying an upcoming curve of the track before the first agent of the plurality of agents of a herd reaches the upcoming curve;
adjusting the velocity of at least one agent located towards the front of the plurality of agents of the herd according to a distance relative to approximately the middle of the plurality of agents, by increasing the velocity of each of the at least one agent proportionally to the distance relative to the middle of the plurality of agents of the herd;
adjusting the velocity of at least one agent located towards the back of the plurality of agents of the herd according to the distance relative to approximately the middle of the plurality of agents of the herd, by decreasing the velocity of each agent proportionally to the distance relative to approximately the middle of the plurality of agents;
identifying that each of the plurality of agents of the herd passed the upcoming curve; and
adjusting the velocity of each agent of the plurality of agents of the herd to the velocity prior to the adjusting before the upcoming curve.

20. The method of claim 1, further comprising:
normalizing the velocity of each of the plurality of agents during navigation of the at least one curve; and
linearly interpolating the normalized velocity vector with a forward vector of each of the plurality of agents.

21. The method of claim 1, further comprising:
designating at least one of the plurality of agents as a leader;
gradually adjusting the velocity of each respective leader based on a random value to increase the speed of the leader relative to the other agents over the length of the track; and
when at least one leader is a distance away from a finish line of track according to a requirement, adjusting at least one of the velocity and position of each respective leader relative to the other agents such that respective leaders reach the finish line according to the designation.

22. The method of claim 21, further comprising:
checking, for each designated leader, whether the respective designated leader is blocked by at least one other agent according to the direction of the velocity vector of the respective designated leader;
when the respective designated leader is blocked by the at least one other agent, adjusting the velocity of the designated leading by increasing the magnitude of the speed component of the velocity, adjusting at least one of the position and velocity of the designated leader to one side, adjusting at least one of the position and velocity of the blocking at least one other agent to another side, wherein the respective designated leader passes the blocking at least one other agent.

23. The method of claim 1, further comprising increasing, for each of the plurality of agents, the inter-agent distance between neighboring agents when a distance to the finish line of the track is less than a requirement.

24. A system for computing instructions that update a rendering of a presentation of an animation of a movement of agents, comprising:
an interface that receives an agent dataset comprising a position and a velocity for each of a plurality of agents moving on a track presented on a display, wherein the velocity is represented as a vector having a magnitude indicative of speed and a direction, wherein the vector is associated with the position defined using a set of coordinates based on a virtual environment representing the track;
a program store storing code; and
at least one processor coupled to the interface and the program store for implementing the stored code, the code comprising:
code to identify at least one curve of the track, perform for each agent of the plurality of agents: identify neighboring agents of the plurality of agents according to the respective position of each of the plurality of agents, compute a respective inter-agent distance to each of the neighboring agents, adjust at least one of the position and the velocity according to the at least one curve and the distance to each of the neighboring agents; and
code to update instructions for rendering a presentation of an animation of a movement of the agents presented on a display according to the adjusted agent dataset that includes the adjusted at least one of the position and velocity of each of the plurality of agents, wherein the performing and the updating are iterated dynamically to provide a realistic animation of the movement of the plurality of agents along the curve of the track.

25. A computer program product comprising a non-transitory computer readable storage medium storing program code thereon for implementation by at least one processor, for computing instructions that update a rendering of a presentation of an animation of a movement of agents, comprising:
instructions to receive an agent dataset comprising a position and a velocity for each of a plurality of agents moving on a track presented on a display, wherein the velocity is represented as a vector having a magnitude indicative of speed and a direction, wherein the vector is associated with the position defined using a set of coordinates based on a virtual environment representing the track;
instructions to identify at least one curve of the track;
instructions to perform, for each agent of the plurality of agents:
identify neighboring agents of the plurality of agents according to the respective position of each of the plurality of agents;
compute a respective inter-agent distance to each of the neighboring agents;
adjust at least one of the position and the velocity according to the at least one curve and the distance to each of the neighboring agents; and
instructions to update instructions for rendering a presentation of an animation of a movement of the agents presented on the display according to the adjusted agent dataset that includes the adjusted at least one of the position and velocity of each of the plurality of agents,
wherein the performing and the updating are iterated dynamically to provide a realistic animation of the movement of the plurality of agents along the curve of the track.
